(19) United States
(12) Patent Application Publication
(10) Pub. No.: US 2009/0236508 A1
(43) Pub. Date: Sep. 24, 2009

(54) Incremental encoder

(75) Inventor: Cheng Chieh Huang, Taipei City (TW)

Correspondence Address: BACON & THOMAS, PLLC, 625 SLATERS LANE, FOURTH FLOOR, ALEXANDRIA, VA, 22314-1176, US

(73) Assignee: CAPELLA MICROSYSTEMS (Taiwan), Ltd., TAIPEI COUNTY (TW)

(21) Appl. No.: 12/076,570

(22) Filed: Mar. 20, 2008

(51) Int. Cl. G01D 5/34

(52) U.S. Cl. 250/231.14

(57) ABSTRACT

An incremental encoder, which comprises a light source, a code wheel, a first photo-sensitive unit, a second photo-sensitive unit, a first inverse-phase photo-sensitive unit and a comparison circuit, is disclosed. The light source provides a detecting light. The code wheel comprises many diaphanous holes. The detecting light is sieved into a light pulse signal by the diaphanous holes when the code wheel is rotating. The first photo-sensitive unit, the second photo-sensitive unit and the first inverse-phase photo-sensitive unit generates the first electronic signal, the second electronic signal and the first inverse-phase electronic signal respectively based on the light pulse signal. The comparison circuit generates a voltage signal by composing the first electronic signal and the first inverse-phase electronic signal, generates a first digital signal based on the voltage signal and the first electronic signal, and generates a second digital signal based on the voltage signal and the second electronic signal.

### BACKGROUND OF THE INVENTION

(a) Field of the Invention

The invention is related to an encoder, and particularly to an incremental encoder.

(b) Description of the Prior Art

The photo-electronic encoder is the most popular motion sensor in industry. It transforms the displacement of a mechanism into a pulse signal or a digitized number by using the photo-electronic technology. The theorem can be realized by taking FIG. 1 into consideration. The photo-electronic encoder is composed by the light source 10, the code wheel 20, the photo-sensitive unit 30 and the detection apparatus 40. The code wheel 20 is a circular board having many rectangular diaphanous holes distributed on itself with equal-range interval. The code wheel 20 is coupled with a mechanism, and the code wheel 20 rotates when the mechanism is moving. The detecting light which comes from the light source 10, such as a light emitting diode, is sieved by the code wheel 20 and transformed into a light pulse signal. The light pulse signal is transmitted into the photo-sensitive unit 30 and further transformed into the electronic signal. The detection apparatus 40 receives the electronic signal and measures the moving speed of the mechanism by calculating the pulse number of the electronic signal. Besides, the code wheel 20 also provides two sets of light pulse signals which are differ in 90° phase angle for expressing the direction of the movement.

Since the photo-electronic encoder is a rotating angle detection apparatus which transforms the displacement of a mechanism into a pulse signal or a digitized number by using the photo-electronic technology, it comprises the benefits such as small volume, high precision, high reliability and digitized interface. Therefore, the photo-electronic encoder is applied widely in the numerical controlled engine, servo driver, robot, radar and military target determination.

Generally speaking, the photo-electronic encoder can be differentiated into incremental encoder, absolute encoder and mixed encoder by their different scales of code wheels and different signal outputs. Here describes the incremental encoder, absolute encoder and mixed encoder briefly as following:

The incremental encoder uses the photo-electronic technology directly, and outputs three sets of square wave pulse signals: A pulse signal, B pulse signal and Z phase signal. Wherein, A pulse signal and B pulse signal are differ in 90° phase angle for expressing the direction of the movement. And Z phase signal is for orientation after each cycle. Its merits comprises simple structure, long mechanical lifetime above several ten thousand hours, high robustness and suitable for long distance transmission. Its shortcoming is that it can't output the signal represents its absolute position.

The absolute encoder is a kind of motion sensor which can output the digitized number directly. The code wheel of the absolute encoder having many bar-code distributed concentrically on itself. The bar-code is formed by many diaphanous fanlights. One side of the code wheel is a light source and the other side of the code wheel is a photo-sensitive unit. The photo-sensitive unit can recognize the position of the code wheel by reading the bar-code, and therefore the absolute encoder doesn't need a counter at all.

The bar-code of the absolute encoder is usually using the binary code or the Gray code. And the absolute encoder comprises the benefits of:

(1) The absolute encoder is capable of reading out the absolute value of the angle directly.

(2) The absolute encoder has no accumulate error.

(3) The position signal won't be lost after the system is shut down.

In comparison with the incremental encoder and the absolute encoder, the characteristic of the mixed encoder is that it outputs two sets of signals. One is for checking the absolute position of the code wheel, and the other is totally the same with the light pulse signal of the incremental encoder.

Please refer to FIG. 2 for the schematic diagram of the structure of the incremental encoder of the prior. Wherein, the light source 10 can be realized by a light emitting diode 11, the light emitting diode 11 provides a detecting light to an incremental code wheel 21. The incremental code wheel 21 is rotated with the movement of a mechanism. The incremental code wheel 21 rotates fast if the mechanism moves fast. The incremental code wheel 21 comprises lots of diaphanous holes. When the incremental code wheel 21 is rotating, the detecting light, which passing through the incremental code wheel 21, will be sieved into a light pulse signal by the diaphanous holes. Four photo diodes 31 are arranged orderly in one side of the incremental code wheel 21 for outputting four sets of electrical signals based on the light pulse signal. And then, the comparison circuit 41 generates two sets of digital signals according to four sets of electrical signals mentioned above. Wherein, the phase priority of the digital signals represents the rotating direction of the incremental code wheel 21, and the frequencies of the digital signals presents the rotating speed of the incremental code wheel 21.

Please refer to FIG. 3 for the schematic diagram of the output signals of the incremental encoder of the prior. In the left part of FIG. 3, the incremental code wheel 21 is rotating to the first direction and the four photo diodes 31 are outputting four sets of electrical signals which are the electrical signal A, the electrical signal B, the electrical signal A_ and the electrical signal B_ in sequence. Wherein, the electrical signal A leads the electrical signal B, the phase of the electrical signal A is totally inverse with the phase of the electrical signal A_, and the phase of the electrical signal B is totally inverse with the phase of the electrical signal B_. Therefore, the comparison circuit 41 generates a first digital signal by subtracting the electrical signal A_ from the electrical signal A, and generates a second digital signal by subtracting the electrical signal B_ from the electrical signal B. Besides, the first digital signal leads the second digital signal.

Similarly, as shown in the right part of FIG. 3, the comparison circuit 41 also generates a first digital signal and a second digital signal when the incremental code wheel 21 is rotating to the second direction. Wherein, the first digital signal lags the second digital signal. However, the incremental encoder mentioned above needs four photo diodes 31, and the cost of the photo diode is higher than the cost of reforming a new comparison circuit to reduce the number of the photo diodes.

In view of the drawbacks of the prior art, the inventor of the present invention based on years of experience in the related industry to conduct extensive researches and experiments, and finally developed an incremental encoder in accordance with the present invention to overcome the aforementioned drawbacks.

### SUMMARY OF THE INVENTION

One objective of the present invention is to provide an incremental encoder for simplifying the structure of the prior. To achieve the objective of the present invention, an incremental encoder for measuring the moving speed of a mechanism is disclosed. Wherein, the incremental encoder comprises a light source, a code wheel, a first photo-sensitive unit, a second photo-sensitive unit, a first inverse-phase photo-sensitive unit and a comparison circuit. The light source provides a detecting light. The code wheel comprises many diaphanous holes and is coupled with the mechanism. In other words, the code wheel rotates when the mechanism is moving. And the detecting light is sieved into a light pulse signal by the diaphanous holes when the code wheel is rotating. The first photo-sensitive unit generates a first electronic signal based on the light pulse signal at a first time. The second photo-sensitive unit generates a second electronic signal based on the light pulse signal at a second time. And the first inverse-phase photo-sensitive unit generates a first inverse-phase electronic signal based on the light pulse signal. The comparison circuit generates a voltage signal by composing the first electronic signal and the first inverse-phase electronic signal. And then, the comparison circuit generates a first digital signal based on the voltage signal and the first electronic signal. Finally, the comparison circuit also generates a second digital signal based on the voltage signal and the second electronic signal.

Besides, the present invention also provides an incremental encoder for measuring the moving speed of a mechanism is disclosed. Wherein, the incremental encoder comprises a light source, a code wheel, a first photo-sensitive unit, a second photo-sensitive unit, a second inverse-phase photo-sensitive unit and a comparison circuit. The light source provides a detecting light. The code wheel comprises many diaphanous holes and is coupled with the mechanism. In other words, the code wheel rotates when the mechanism is moving. And the detecting light is sieved into a light pulse signal by the diaphanous holes when the code wheel is rotating. The first photo-sensitive unit generates a first electronic signal based on the light pulse signal at a first time. The second photo-sensitive unit generates a second electronic signal based on the light pulse signal at a second time. And the second inverse-phase photo-sensitive unit generates a second inverse-phase electronic signal based on the light pulse signal. The comparison circuit generates a voltage signal by composing the second electronic signal and the second inverse-phase electronic signal. And then, the comparison circuit generates a first digital signal based on the voltage signal and the first electronic signal. Finally, the comparison circuit also generates a second digital signal based on the voltage signal and the second electronic signal. As mentioned above, the incremental encoder of the present invention only needs three photo-sensitive units to achieve the purpose of generating the first digital signal and the second digital signal.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is the function block of the encoder of the prior.

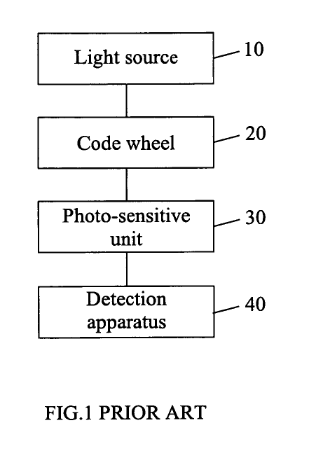

FIG. 2 is the schematic diagram of the structure of the incremental encoder of the prior.

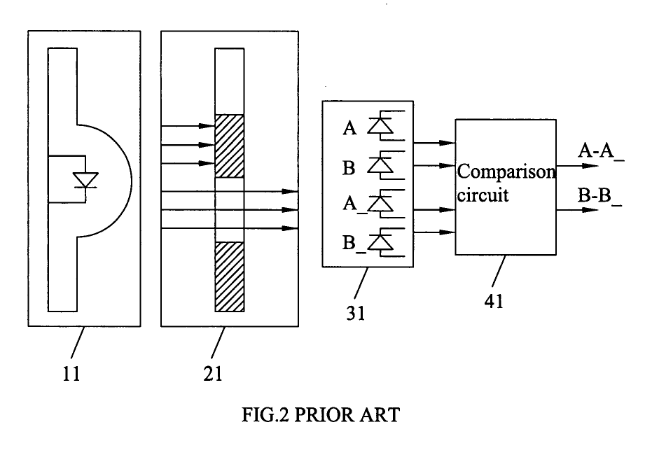

FIG. 3 is the schematic diagram of the output signals of the incremental encoder of the prior.

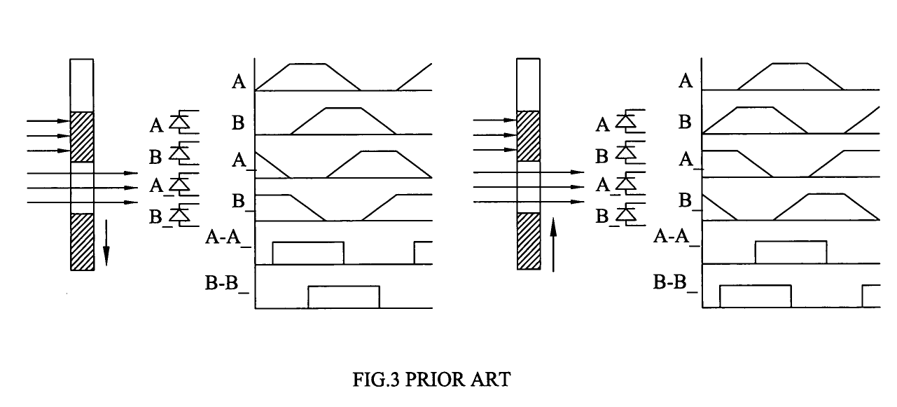

FIG. 4 is the schematic diagram of the structure of the incremental encoder of the present invention.

FIG. 5 is the schematic diagram of the output signals of the incremental encoder of the present invention.

FIG. 6 is the circuit structure diagram of one embodiment of the incremental encoder of the resent invention.

FIG. 7 is the circuit structure diagram of another embodiment of the incremental encoder of the resent invention.

FIG. 8 is another schematic diagram of the structure of the incremental encoder of the present invention.

### DETAILED DESCRIPTION OF THE PREFERRED EMBODIMENTS

In the related figures of preferred embodiments of the incremental encoder of the present invention, the same referring numerals are used for the same components in accordance with the present invention.

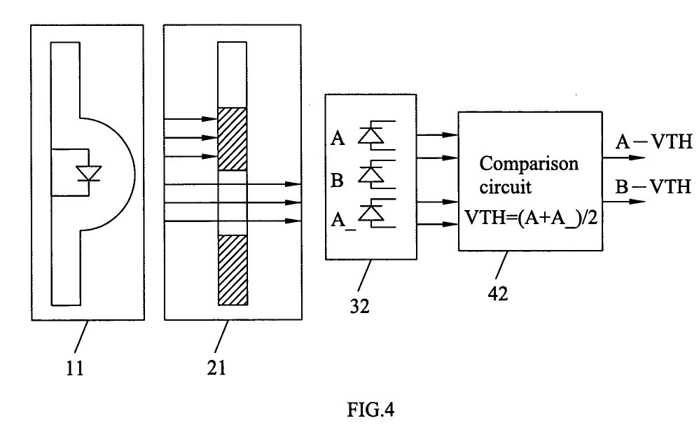

Please refer to FIG. 4 for the schematic diagram of the structure of the incremental encoder of the present invention. Wherein, the photo diodes 32 only needs three photo-sensitive units to transform the light pulse signal into the electronic signal A, the electronic signal B and the electronic signal A_ in sequence. And then, the comparison circuit 42 generates a voltage signal VTH by composing the electronic signal A with the electronic signal A_. The comparison circuit 42 generates a first digital signal by subtracting the voltage signal VTH from the electronic signal A, and then generates a second digital signal by subtracting the voltage signal VTH from the electronic signal B.

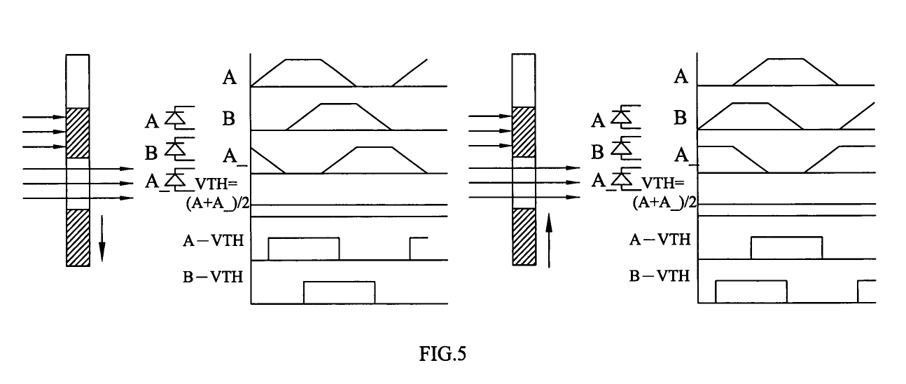

Please refer to FIG. 5 for the schematic diagram of the output signals of the incremental encoder of the present invention. Wherein, the photo diodes 32 generates the electronic signal A, the electronic signal B and the electronic signal A_ in sequence when the incremental code wheel 21 is rotating to the first direction. Since the phase of the electronic signal A is totally inverse with the phase of the electronic signal A_, the electronic signal A and the electronic signal A_ are added up by the comparison circuit 42, and the result of the addition is divided by 2 in use of the comparison circuit 42 to generate a voltage signal VTH. And then, the comparison circuit 42 generates a first digital signal by subtracting the voltage signal VTH from the electronic signal A, and generates a second digital signal by subtracting the voltage signal VTH from the electronic signal B. Wherein, the first digital signal leads the second digital signal. Similarly, the comparison circuit 42 also generates a first digital signal and a second digital signal, which the first digital signal lags the second digital signal, when the incremental code wheel 21 is rotating to the second direction.

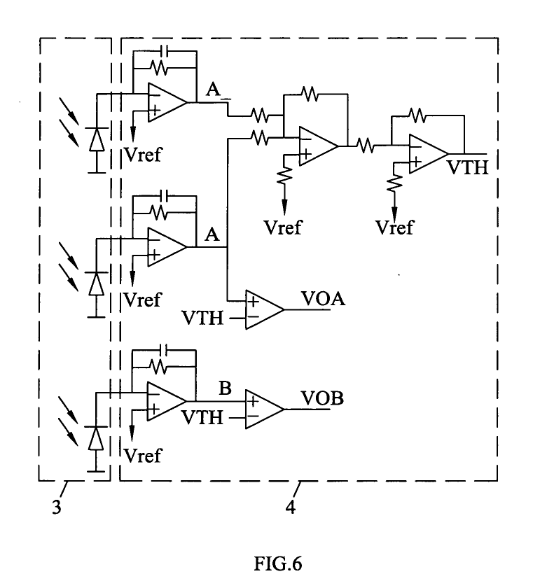

Please refer to FIG. 6 for the circuit structure diagram of one embodiment of the incremental encoder of the resent invention. Wherein, the photo-sensitive unit 33 can be realized by a photo diode or a photosensitive resistor. The comparison circuit 43 comprises many comparators. In the embodiment, the comparison circuit 43 uses the comparator M and the comparator N to compose the electronic signal A and the electronic signal A_ into the voltage signal VTH. And then, the comparison circuit 43 generates a first digital signal VOA by subtracting the voltage signal VTH from the electronic signal A, and generates a second digital signal VOB by subtracting the voltage signal VTH from the electronic signal B.

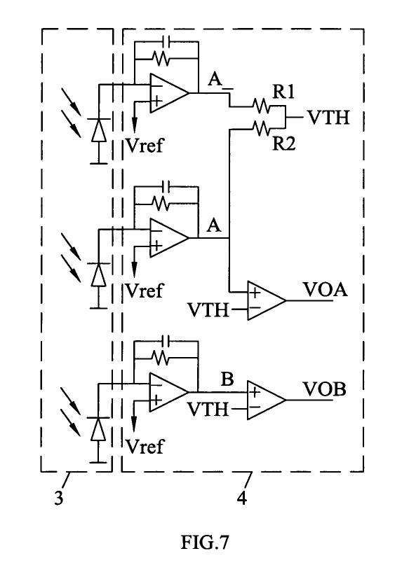

Please refer to FIG. 7 for the circuit structure diagram of another embodiment of the incremental encoder of the resent invention. Wherein, the comparison circuit 44 generates the voltage signal VTH by composing the electronic signal A and the electronic signal A_ through the resistor R1 and the resistor R2. And then, the comparison circuit 44 generates a first digital signal VOA by subtracting the voltage signal VTH from the electronic signal A, and generates a second digital signal VOB by subtracting the voltage signal VTH from the electronic signal B.

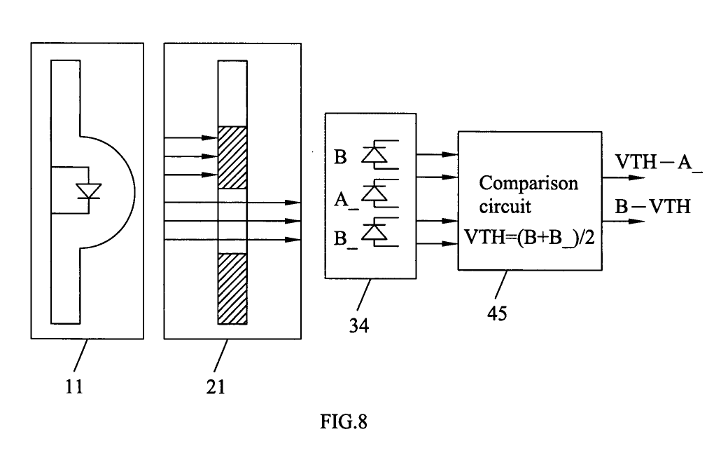

Please refer to FIG. 8 for another schematic diagram of the structure of the incremental encoder of the present invention. Wherein, the photo diodes 32 only needs three photo-sensitive units to transform the light pulse signal, which comes from the light emitting diode 1, into the electronic signal A, the electronic signal B and the electronic signal B_ in sequence. And then, the comparison circuit 42 generates a voltage signal VTH by composing the electronic signal B with the electronic signal B_. The comparison circuit 42 generates a first digital signal by subtracting the voltage signal VTH from the electronic signal A, and then generates a second digital signal by subtracting the voltage signal VTH from the electronic signal B. In conclusion, the incremental encoder of the present invention only needs three photo-sensitive units, and is capable of covering all benefits of the prior.

The one to deserve to be mentioned is that the incremental encoder of the present invention is suitable to be applied on a printer. When the printer is feeding or sending paper, the distance and the rotation speed of the cylinder have to be calculated precisely for preventing the paper from being located at unsuitable location. However, the absolute position of the cylinder is meaningless for the printer. Besides, the encoder of the printer requires long mechanical lifetime above several ten thousand hours and high robustness. Therefore, the incremental encoder of the present invention is suitable to be applied on a printer.

While the present invention has been described by way of example and in terms of a preferred embodiment, it is to be understood that the present invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An incremental encoder, for measuring the moving speed of a mechanism, comprising:
a light source for providing a detecting light;
a code wheel having a plurality of diaphanous holes and being coupled with said mechanism, said code wheel rotates when said mechanism is moving, and said detecting light is sieved into a light pulse signal by said plurality of diaphanous holes;
a first photo-sensitive unit for generating a first electronic signal based on said light pulse signal at a first time;
a second photo-sensitive unit for generating a second electronic signal based on said light pulse signal at a second time;
a first inverse-phase photo-sensitive unit for generating a first inverse-phase electronic signal; and
a comparison circuit for generating a voltage signal by composing said first electronic signal and said first inverse-phase electronic signal, generating a first digital signal based on said voltage signal and said first electronic signal, and generating a second digital signal based on said voltage signal and said second electronic signal.

2. The incremental encoder of claim 1, wherein said first time is earlier than said second time and said first digital signal leads said second digital signal when said code wheel is rotating to a first direction.

3. The incremental encoder of claim 1, wherein said first time is later than said second time and said first digital signal lags said second digital signal when said code wheel is rotating to a second direction.

4. The incremental encoder of claim 1, wherein said light source is a light emitting diode.

5. The incremental encoder of claim 1, wherein said first photo-sensitive unit is a photo diode.

6. The incremental encoder of claim 1, wherein said second photo-sensitive unit is a photo diode.

7. The incremental encoder of claim 1, wherein said first inverse-phase photo-sensitive unit is a photo diode.

8. An incremental encoder, for measuring the moving speed of a mechanism, comprising:
a light source for providing a detecting light;
a code wheel having a plurality of diaphanous holes and being coupled with said mechanism, said code wheel rotates when said mechanism is moving, and said detecting light is sieved into a light pulse signal by said plurality of diaphanous holes;
a first photo-sensitive unit for generating a first electronic signal based on said light pulse signal at a first time;
a second photo-sensitive unit for generating a second electronic signal based on said light pulse signal at a second time;
a second inverse-phase photo-sensitive unit for generating a second inverse-phase electronic signal; and
a comparison circuit for generating a voltage signal by composing said second electronic signal and said second inverse-phase electronic signal, generating a first digital signal based on said voltage signal and said first electronic signal, and generating a second digital signal based on said voltage signal and said second electronic signal.

9. The incremental encoder of claim 8, wherein said first time is earlier than said second time and said first digital signal leads said second digital signal when said code wheel is rotating to a first direction.

10. The incremental encoder of claim 8, wherein said first time is later than said second time and said first digital signal lags said second digital signal when said code wheel is rotating to a second direction.

11. The incremental encoder of claim 8, wherein said light source is a light emitting diode.

12. The incremental encoder of claim 8, wherein said first photo-sensitive unit is a photo diode.

13. The incremental encoder of claim 8, wherein said second photo-sensitive unit is a photo diode.

14. The incremental encoder of claim 8, wherein said second inverse-phase photo-sensitive unit is a photo diode.
